(19) United States
(12) Patent Application Publication
(10) Pub. No.: US 2008/0181528 A1
(43) Pub. Date: Jul. 31, 2008

(54) Faster serial method for continuously varying Gaussian filters

(75) Inventor: Hawley Rising, San Jose, CA (US)

Correspondence Address: Jonathan O. Owens;HAVERSTOCK & OWENS LLP, 162 North Wolfe Road, Sunnyvale, CA, 94086, US

(73) Assignees: Sony Corporation; Sony Electronics Inc.

(21) Appl. No.: 11/698,328

(22) Filed: Jan. 25, 2007

(51) Int. Cl. G06K 9/40

(52) U.S. Cl. 382/264

(57) ABSTRACT

A fast method of implementing a recursive IIR filter, by using the data generated by the Thomas Algorithm for processing the first k pixels of an image, where k is a function of the convergence speed of the Gaussian filter is described herein. For all other pixels in the image, each current pixel is a function of that pixel and a fixed fraction where the fixed fraction is the product of the solution to the Gaussian quadratic and the previous pixel.

### FIELD OF THE INVENTION

The present invention relates to the field of imaging. More specifically, the present invention relates to imaging using an improved Gaussian filter.

### BACKGROUND OF THE INVENTION

Gaussian blur is a widely used effect in graphics software. It is typically used to reduce image noise and reduce detail levels, so that the image appears smoother. Gaussian smoothing is also used as a pre-processing stage in computer vision algorithms to enhance image structures at different scales.

Applying a Gaussian blur to an image is the same as convolving the image with a Gaussian or normal distribution. Since the Fourier transform of a Gaussian is another Gaussian, applying a Gaussian blur has the effect of low pass filtering the image, thus smoothing out sharp edges and reducing noise.

Time reversal filters are used for processing both audio and video signals. For spatially filtering images, a separable filter, such as a Gaussian filter, is particularly desirable. Each horizontal scan line of pixels is filtered independently, then each vertical column of pixels is similarly filtered. If the filter is a true Gaussian filter, then the resulting filtering of the two dimensional image is radially symmetric. That is, at any arbitrary angle through the image, the resulting filtered image will be the same as if the line of pixels at such arbitrary angle were directly filtered by the Gaussian filter. To the extent that a close approximation to a Gaussian filter is used, the resulting image filtering is close to radially symmetric. Due to its symmetry, the ideal Gaussian filter has no phase shift over all frequencies of interest.

One of the most important applications of Gaussian filtering is for sharpening, or edge enhancement. Gaussian filtering to sharpen an image is especially desirable when a photographic original has been scanned at very high resolution. Scanning an image at very high resolution, then sharpening using Gaussian filtering, produces an image with minimal image artifacts. The rotational symmetry of the Gaussian filter means that lines of any angle will be sharpened by an identical amount. Thus, the Gaussian filtering is popular for very high quality image processing systems.

Another application of Gaussian filtering is removing film grain, unwanted screens (as when scanning photos from a magazine), as well as other unwanted artifacts.

A drawback to Gaussian filtering is its relatively great computational cost. Most digital implementations of a Gaussian filter use Finite Impulse Response (FIR) filters. The larger the extent, or, equivalently, the lower the cutoff frequency of the Gaussian filter, the more computationally expensive it is to implement. A typical implementation requires dozens of multiplications per pixel. Further, because the shape of the Gaussian curve is infinite in extent, practical implementations must truncate the actual curve, which can cause quality problems.

### SUMMARY OF THE INVENTION

A fast method of implementing a recursive IIR filter, by using the data generated by the Thomas Algorithm for processing the first k pixels of an image, where k is a function of the convergence speed of the Gaussian filter is described herein. For all other pixels in the image, each current pixel is a function of that pixel and a fixed fraction where the fixed fraction is the product of the solution to the Gaussian quadratic and the previous pixel.

In one aspect, a method of implementing a fast recursive Gaussian Infinite Impulse Response (IIR) filter comprises processing a set of first k pixels of an image with data generated by a Thomas algorithm and processing a set of non-first k pixels of the image using a function of a pixel and a fixed fraction wherein the fixed fraction is a product of a solution to a Gaussian quadratic and a previous pixel. The processing is serial. The method includes k is a function of convergence speed of the Gaussian IIR filter. The method includes k is less than 4. Alternatively, the method as claimed in claim 1 wherein k is less than 8.

In another aspect, a method of manipulating an image comprises acquiring an image, filtering the image, wherein filtering includes: processing a set of first k pixels of the image with data generated by a Thomas algorithm, wherein k is a function of convergence speed of a Gaussian Infinite Impulse Response (IIR) filter and processing a set of non-first k pixels of the image using a function of a pixel and a fixed fraction wherein the fixed fraction is a product of a solution to a Gaussian quadratic and a previous pixel and displaying the image. The processing is serial. The method includes k is less than 4. Alternatively, the method includes k is less than 8.

In another aspect, an apparatus for filtering an image comprises a processor and a program for utilizing the processor for: processing a set of first k pixels of the image with data generated by a Thomas algorithm, wherein k is a function of convergence speed of a Gaussian Infinite Impulse Response (IIR) filter and processing a set of non-first k pixels of the image using a function of a pixel and a fixed fraction wherein the fixed fraction is a product of a solution to a Gaussian quadratic and a previous pixel. The apparatus further comprises a memory coupled to the processor for storing the data. The processing is serial. The apparatus includes k is less than 4. The apparatus includes k is less than 8. The apparatus is selected from the group consisting of a digital camcorder, a digital camera, a cellular phone, PDA and a computer.

In yet another embodiment, an apparatus for acquiring, filtering and displaying an image comprises an acquisition unit for acquiring the image, a processor coupled to the acquisition unit for processing the image, a program for utilizing the processor for: processing a set of first k pixels of the image with data generated by a Thomas algorithm, wherein k is a function of convergence speed of a Gaussian Infinite Impulse Response (IIR) filter and processing a set of non-first k pixels of the image using a function of a pixel and a fixed fraction wherein the fixed fraction is a product of a solution to a Gaussian quadratic and a previous pixel and a display unit coupled to the processor for displaying the image. The apparatus further comprises a memory coupled to the processor for storing the data. The processing is serial. The apparatus includes k is less than 4. The apparatus includes k is less than 8. The apparatus is selected from the group consisting of a digital camcorder, a digital camera, a cellular phone, PDA and a computer.

### BRIEF DESCRIPTION OF THE DRAWINGS

FIG. 1 illustrates a flowchart of a process of implementing a faster serial method for continuously varying Gaussian filters using a computing device.

FIG. 2 illustrates a flowchart of a process of filtering an image using a faster serial method for continuously varying Gaussian filters.

FIG. 3 illustrates a block diagram of a device for implementing a faster serial method for continuously varying Gaussian filters.

### DETAILED DESCRIPTION OF THE PREFERRED EMBODIMENT

Guassian filters are common smoothing filters used widely in image editing, image analysis and computer vision. If implemented as Finite Impulse Response (FIR) filters, they touch each pixel k times per dimension where k is the number of taps in the filter. This is sometimes implemented efficiently in parallel. For strictly serial processing environments, sometimes FIR filters are improved by using Infinite Impulse Response (IIR) filters. A very fast IIR filter has been developed which makes two passes over the data using the Thomas algorithm for multiplication by a sparse matrix to implement the Additive Operator Splitting (AOS) technique for numerically solving second order parabolic differential equations. When the technique is used to solve a heat equation, the result is that since the Gaussian filter solves the heat equation for a point heat source, the solution is iterated by a step that is a tridiagonal matrix. The values in the matrix make it possible to use a pair of passes over each row or column of data, cumulatively adding values and dividing the result.

A faster and improved method of doing this involves noticing the effect that the tridiagonal matrix has on the set of additive values. Since the current term is divided into the previous term, writing out the operation, and combining terms for a pixel in the middle of the image, a continued fraction multiple of the most recently summed pixel data is obtained. The continued fraction converges quickly, and since it is calculable from the fraction by generating the quadratic equation that solves for the fraction of the surrounding pixels needed to be added, a new implementation is developed. For the first k pixels, defined by the convergence speed, which is usually less than four and certainly less than eight for all but the widest Gaussian filters, the Thomas algorithm supplied terms are used because they form the boundary terms necessary for the edge of the screen. For all other pixels, the non-first k pixels of the image are processed using a function of a pixel and a fixed fraction wherein the fixed fraction is a product of a solution to a Gaussian quadratic and a previous pixel. The method is also completed in two passes, but uses a constant times each pixel instead of a calculated value, thus it is much faster.

The Thomas algorithm is as follows.

Assuming the data stream is N pixels long:

rₗ=σ²/2

calculate:

α=1+rₗ

m₀=1+rₗ

l₀=−rₗ/m₀

for i>0,

mᵢ=α+rₗlᵢ₋₁

lᵢ=rₗ/mᵢ

And finally, at the end of the row,

m_{N-1}=1+rₗ+rₗl_{N-2}

This sets up the coefficients and multipliers. The row calculation is then

y₀=row[0]

yᵢ=row[i]−lᵢ₋₁yᵢ

Coming back there is

out[N−1]=y_{N-1}/m_{N-1}

out[i]=(yᵢ+rₗout[i−1])/mᵢ

By looking at the set of equations above, mᵢ is assigned a value that is recursive and contains a division. Specifically,

$$\begin{matrix}{m}_{i} = α + {r}_{l} {l}_{i - 1} \\ = α + {r}_{l} ( {r}_{l} / {m}_{i - 1} ) \\ = α + {r}_{l} ( {r}_{l} / ( α + {r}_{l} {l}_{i - 2} ) ) \\ = α + \frac{{r}_{l}^{2}}{a + \frac{{r}_{l}^{2}}{⋯}}\end{matrix}$$

Since each of these continued fractions for mᵢ is identical, so long as it is not near the edges of the raster line, and since the continued fractions converge in value after a few coefficients, the simple way to calculate the Gaussian filter is by first calculating the value of the continued fraction, then only doing calculations for the coefficients near the edges of the image rows (or columns). The calculation is a standard calculation in continued fractions, yielding:

$$γ = \frac{2}{α + \sqrt{{α}^{2} + {r}_{l}^{2}}}$$

β=rₗγ

y[i]=row[i]+βy[i−1]

out[i]=γy[i]+βout[i+1]

This method is clearly a faster calculation compared to that of the Thomas algorithm.

The start and end coefficients are calculated the same way, except for:

γₛₜₐᵣₜ=γ−rₗ.

The most general form of the method, which allows filters other than Gaussian to be generated, requires that the coefficients of the continued fraction approximation to the filter be all of one sign. For alternating or varying signs, the discriminant of the resultant quadratic equation must be elliptical (no real roots, two complex roots) to ensure convergence. The speed of convergence will determine how many terms there are in the resultant filter, and how many terms must be summed using AOS to do the boundary conditions. The slowest converging sequence for all one sign is the golden mean (continued fraction =[1,1,1,1, . . . ]), for varying signs it can be slower, and if too slow, the algorithm is not feasible.

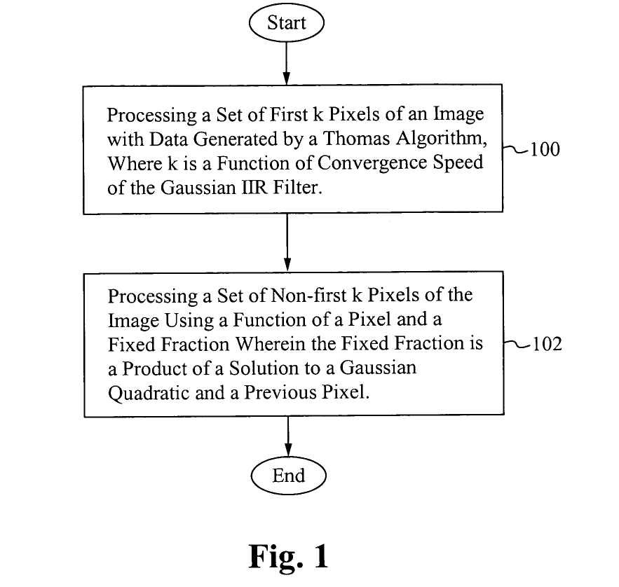

FIG. 1 illustrates a flow chart of a process of implementing a faster serial method for continuously varying Gaussian filters using a computing device. In the step 100, a set of first k pixels of an image are processed with data generated by a Thomas algorithm, where k is a function of convergence speed of the Gaussian IIR filter. In the step 102, a set of non-first k pixels of the image are processed using a function of a pixel and a fixed fraction wherein the fixed fraction is a product of a solution to a Gaussian quadratic and a previous pixel.

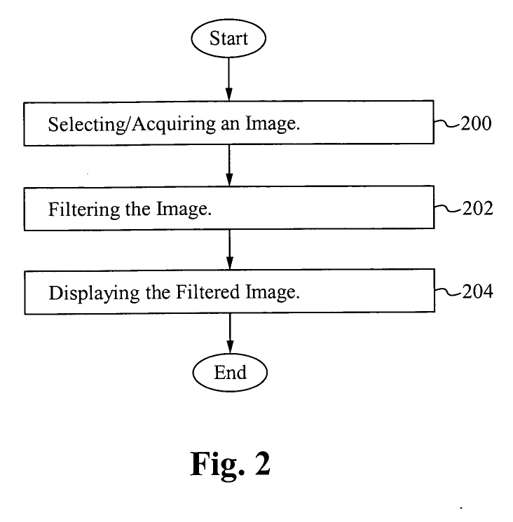

FIG. 2 illustrates a flowchart of a process of filtering an image using a faster serial method for continuously varying Gaussian filters. In the step 200, an image or a part of an image is acquired. When utilizing the method described herein with a previously captured image, such as with a photo editing program, then a user selects/acquires the image or part of the image to be filtered. When the method is implemented in a camera or other device which acquires the image, then the image is able to be directly filtered. In the step 202, the image or image segment is filtered using the faster serial method. As described above, the filtering method implements Gaussian filtering which has been improved for speed. By utilizing continued fractions in the process, constants are used instead of calculations, thus minimizing the processing requirements. In the step 204, the filtered image or image segment is displayed wherein the image has been smoothed or sharpened as desired.

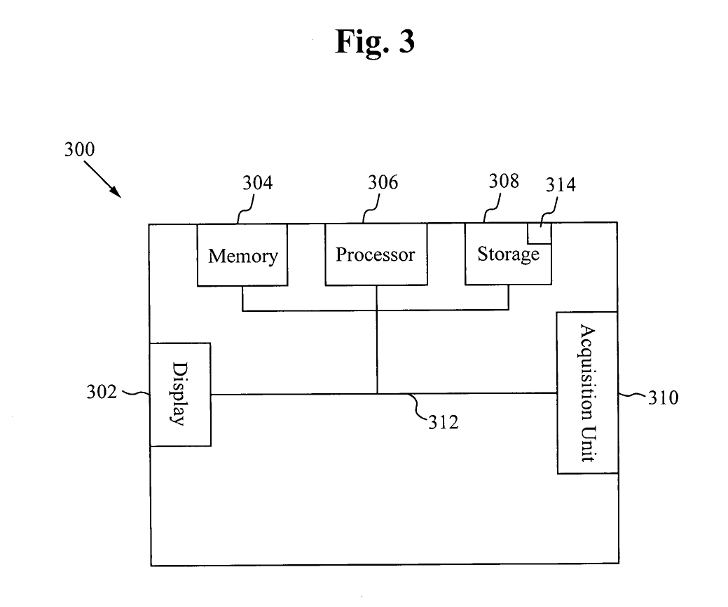

FIG. 3 illustrates a block diagram of a device for implementing a faster serial method for continuously varying Gaussian filters. A computing device 300 includes a number of elements: a display 302, a memory 304, a processor 306, a storage 308, an optional acquisition unit 310 and a bus 312 to couple the elements together. The acquisition unit 310 acquires image data which is then processed by the processor 306 and temporarily stored on the memory 304 and more permanently on the storage 308. The display 302 displays the image data acquired either during acquisition or when utilizing a playback feature. When the faster serial method for continuously varying Gaussian filters described herein is implemented in software, an application 314 resides on the storage 308, and the processor 306 processes the necessary data while the amount of the memory 304 used is minimized. When implemented in hardware, additional components are utilized to process the data. The computing device 300 is able to be, but is not limited to, a digital camcorder, a digital camera, a cellular phone, PDA or a computer.

To utilize the faster serial method for continuously varying Gaussian filters, a user does not implement a device any differently than a device not implementing the technology. A device configured accordingly will automatically utilize the faster serial method for continuously varying Gaussian filters. The device utilizes the Thomas algorithm for the first k pixels where k is defined by the convergence speed. This forms the boundary terms necessary for the edge of the screen. For the other pixels, the current pixel is a fraction of that pixel and a fixed fraction where the fixed fraction is the product of the solution to the Gaussian quadratic and the previous pixel. In doing so, the device no longer requires additional calculations, and thus saves time.

In operation, the faster serial method for continuously varying Gaussian filters is able to perform the Gaussian filter more efficiently and thus more quickly than previous attempts. By minimizing the amount of calculations required and instead developing a constant from the continued fraction, processing time, power and space are saved.

The method described herein is able to be used to soften images, remove artifacts and to smooth general signals amongst other implementations.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of implementing a fast recursive Gaussian Infinite Impulse Response (IIR) filter comprising:
a. processing a set of first k pixels of an image with data generated by a Thomas algorithm; and
b. processing a set of non-first k pixels of the image using a function of a pixel and a fixed fraction wherein the fixed fraction is a product of a solution to a Gaussian quadratic and a previous pixel.

2. The method as claimed in claim 1 wherein the processing is serial.

3. The method as claimed in claim 1 where k is a function of convergence speed of the Gaussian IIR filter.

4. The method as claimed in claim 1 wherein k is less than 4.

5. The method as claimed in claim 1 wherein k is less than 8.

6. A method of manipulating an image comprising:
a. acquiring an image;
b. filtering the image, wherein filtering includes:
i. processing a set of first k pixels of the image with data generated by a Thomas algorithm, wherein k is a function of convergence speed of a Gaussian Infinite Impulse Response (IIR) filter; and
ii. processing a set of non-first k pixels of the image using a function of a pixel and a fixed fraction wherein the fixed fraction is a product of a solution to a Gaussian quadratic and a previous pixel; and
c. displaying the image.

7. The method as claimed in claim 6 wherein the processing is serial.

8. The method as claimed in claim 6 wherein k is less than 4.

9. The method as claimed in claim 6 wherein k is less than 8.

10. An apparatus for filtering an image comprising:
a. a processor; and
b. a program for utilizing the processor for:
i. processing a set of first k pixels of the image with data generated by a Thomas algorithm, wherein k is a function of convergence speed of a Gaussian Infinite Impulse Response (IIR) filter; and
ii. processing a set of non-first k pixels of the image using a function of a pixel and a fixed fraction wherein the fixed fraction is a product of a solution to a Gaussian quadratic and a previous pixel.

11. The apparatus as claimed in claim 10 further comprising a memory coupled to the processor for storing the data.

12. The apparatus as claimed in claim 10 wherein the processing is serial.

13. The apparatus as claimed in claim 10 wherein k is less than 4.

14. The apparatus as claimed in claim 10 wherein k is less than 8.

15. The apparatus as claimed in claim 10 wherein the apparatus is selected from the group consisting of a digital camcorder, a digital camera, a cellular phone, PDA and a computer.

16. An apparatus for acquiring, filtering and displaying an image comprising:
a. an acquisition unit for acquiring the image;
b. a processor coupled to the acquisition unit for processing the image;
c. a program for utilizing the processor for:
i. processing a set of first k pixels of the image with data generated by a Thomas algorithm, wherein k is a function of convergence speed of a Gaussian Infinite Impulse Response (IIR) filter; and
ii. processing a set of non-first k pixels of the image using a function of a pixel and a fixed fraction wherein the fixed fraction is a product of a solution to a Gaussian quadratic and a previous pixel; and
d. a display unit coupled to the processor for displaying the image.

17. The apparatus as claimed in claim 16 further comprising a memory coupled to the processor for storing the data.

18. The apparatus as claimed in claim 16 wherein the processing is serial.

19. The apparatus as claimed in claim 16 wherein k is less than 4.

20. The apparatus as claimed in claim 16 wherein k is less than 8.

21. The apparatus as claimed in claim 16 wherein the apparatus is selected from the group consisting of a digital camcorder, a digital camera, a cellular phone, PDA and a computer.
